(19) United States
(12) Patent Application Publication
(10) Pub. No.: US 2024/0361554 A1
(43) Pub. Date: Oct. 31, 2024

(54) FIBER OPTIC CASSETTE CONFIGURED TO PROVIDE ENHANCED PROTECTION OF OPTICAL FIBERS

(71) Applicant: BELDEN CANADA ULC, SAINT-LAURENT (CA)

(72) Inventors: Jaber AHMAD, Montreal (CA); Luc MILETTE, Montreal (CA); Moise LEVY, Laval (CA); Christian ROA-QUISPE, Laval (CA)

(73) Assignee: BELDEN CANADA ULC, SAINT-LAURENT (CA)

(21) Appl. No.: 18/646,583

(22) Filed: Apr. 25, 2024

Related U.S. Application Data
(60) Provisional application No. 63/498,064, filed on Apr. 25, 2023.

(51) Int. Cl. G02B 6/44

(52) U.S. Cl. CPC G02B 6/4453

(57) ABSTRACT

A fiber optic cassette may include a cable portion including an arrangement of optical fibers and a substrate portion configured to support the arrangement of optical fibers, and a body portion configured to receive the cable portion. The optical fibers may each include a first fiber end portion that is configured to stand free of the substrate and a second fiber end portion that is configured to stand free of a second end of the substrate opposite the first substrate end. The first fiber end portion may be configured to be at least partially covered by a protective portion and the second fiber end portion may be configured to be at least partially covered by a cover portion. A substrate facing protective portion of the protective portion may be configured to be at least partially surrounded by the substrate portion, a substrate facing cover portion of the cover portion may be configured to be at least partially surrounded by the substrate portion, and a middle fiber portion of each of the optical fibers may be configured to extend from the first fiber end portion to the substrate facing cover portion of the cover portion that is at least partially surrounded by the substrate portion such that the cassette is configured to provide enhanced protection of at least one of the arrangement of optical fibers.

### CROSS-REFERENCE TO RELATED APPLICATION

This application claims the benefit of U.S. Provisional Patent Application No. 63/498,064, filed Apr. 25, 2023, pending, the disclosure of which is hereby incorporated by reference herein in its entirety.

### TECHNICAL FIELD

The present invention relates generally to fiber optic cassettes, and more particularly to a fiber optic cassette that is configured to provide enhanced protection of optical fibers therein.

### BACKGROUND

Some conventional fiber optic cassettes provide a multi-fiber input port that receives a multi-fiber plug, for example, a multi-fiber push on (MPO) plug that terminates a multi-fiber cable, and a plurality of output ports that receive an optical fiber plug, for example, a Lucent Connector (LC) type plug that terminates a single optical fiber cable. Such conventional cassettes contain a plurality of optical fibers therein. The optical fibers break out the multiple fibers input via the multi-fiber able to a plurality of separate optical fibers that couple with the output ports. One drawback of such cassettes is that the optical fibers are placed freely within the cassette body and are thus susceptible to damage and the like.

It may be desirable to provide a fiber optic cassette that is configured to provide enhanced protection of optical fibers contained therein. It may also be desirable to provide such enhanced protection without adding to the thickness of the fiber optic cassette. It may also be desirable to enhance management of optical fibers in the fiber optic cassette.

### SUMMARY

In accordance with various aspects of the disclosure, a fiber optic cassette configured to provide enhanced protection of optical fibers therein may include a body portion comprising a front portion, a back portion opposite the front portion, and a pair of opposed side portions and a cable portion including an arrangement of optical fibers and a substrate portion configured to support the arrangement of optical fibers each of the optical fibers may be terminated at a first end by a plug, and all of the optical fibers may be terminated at a second end by a multifiber plug. The front portion, the back portion, and the opposed side portions may be structurally configured to together may define a receiving region that is configured to receive the cable portion, the first ends of the optical fibers may stand free of and are equally spaced along a first end of the substrate, and the second ends of the optical fibers may stand free of a second end of the substrate opposite the first substrate end. The first ends of the optical fibers may each be covered by a protective portion, the second ends of the optical fibers may be covered by a cover portion, and an engagement portion may be configured to extend into the receiving region and retain the substrate portion in the receiving region. A first end portion of the protective portion may be configured to be at least partially surrounded by the substrate portion, a portion of the cover portion may be configured to be at least partially surrounded by the substrate portion, and a middle portion of each of the optical fibers that may extend from the first end portion to the portion of the cover portion that may be configured to be at least partially surrounded by the substrate portion such that the cassette is configured to provide enhanced protection of the optical fibers in the receiving region.

In some embodiments of the foregoing fiber optic cassette, the substrate portion may include two opposed substrates that are configured to sandwich the middle portion of the cable portion there between. In some embodiments of any of the foregoing fiber optic cassettes, the two opposed substrates may be configured to be secured together by an adhesive portion.

In some embodiments of any of the foregoing fiber optic cassettes, the middle portion of the cable portion may be at least partially embedded in the substrate portion.

In some embodiments of any of the foregoing fiber optic cassettes, the substrate portion may include an opening portion that is configured to permit the engagement portion to pass there through and engage the substrate portion so as to at least partially retain the substrate portion in the receiving region. In some embodiments, the engagement portion may comprise a pair of flexible fingers that are configured to be inserted through the opening portion and engage a surface of the substrate portion so as to at least partially retain the substrate portion in the receiving region.

In accordance with various aspects of the disclosure, a fiber optic cassette configured to provide enhanced protection of optical fibers therein may include a cable portion including an arrangement of optical fibers and a substrate portion configured to support the arrangement of optical fibers, and a body portion configured to receive the cable portion. The optical fibers may each include a first fiber end portion that is configured to stand free of the substrate and a second fiber end portion that is configured to stand free of a second end of the substrate opposite the first substrate end. The first fiber end portion may be configured to be at least partially covered by a protective portion and the second fiber end portion may be configured to be at least partially covered by a cover portion. A substrate facing protective portion of the protective portion may be configured to be at least partially surrounded by the substrate portion, a substrate facing cover portion of the cover portion may be configured to be at least partially surrounded by the substrate portion, and a middle fiber portion of each of the optical fibers may be configured to extend from the first fiber end portion to the substrate facing cover portion of the cover portion that is at least partially surrounded by the substrate portion such that the cassette is configured to provide enhanced protection of at least one of the arrangement of optical fibers.

In some embodiments of any of the foregoing fiber optic cassettes, the body portion may include a front portion, a back portion opposite the front portion, and a pair of opposed side portions connecting the front portion and the back portion, and the front portion, the back portion, and the opposed side portions together may define a receiving region that is structurally configured to receive the cable portion.

In some embodiments of the foregoing fiber optic cassettes, the substrate portion may include two opposed substrates that are configured to sandwich the middle portion of the cable portion there between. In some embodiments of any of the foregoing fiber optic cassettes, the two opposed substrates may be secured together via an adhesive.

In some embodiments of any of the foregoing fiber optic cassettes, the middle portion of the cable portion may be embedded in the substrate portion.

In some embodiments of any of the foregoing fiber optic cassettes, an engagement portion that may be configured to extend into the receiving region and retain the substrate portion in the receiving region. In some embodiments, the substrate portion may include an opening substrate portion that is configured to permit the engagement portion to pass there through and engage the opening substrate portion so as to retain the substrate portion in the receiving region. In some embodiments, the engagement portion may include a pair of flexible fingers that are configured to be at least partially inserted through the opening portion so as to engage a surface of the substrate portion and retain the substrate portion in at least a portion of the receiving region.

According to various aspects of the disclosure, a cable portion configured to provide enhanced protection of optical fibers may include an arrangement of optical fibers and a substrate portion configured to hold at least a portion of the arrangement of optical fibers such that at least a first optical fiber end portion of the arrangement of optical fibers stands free of a first substrate end portion of the substrate portion and a second optical fiber end portion of the arrangement of optical fibers stand free of a second substrate end portion of the substrate portion. The first optical fiber end portion of the arrangement of optical fibers may be configured to be at least partially covered by a protective portion and the second optical fiber end portion of the arrangement of optical fibers may be configured to be at least partially covered by a cover portion. A substrate facing protective portion of the protective portion may be configured to be at least surrounded by the substrate portion, a substrate facing cover portion of the cover portion may be configured to be at least surrounded by the substrate portion, and an intermediate optical fiber portion of the arrangement of optical fibers may be configured to extend from the first end portion of the substrate facing cover portion of the cover portion that is at least partially surrounded by the substrate portion such that the cable portion is configured to provide enhanced protection of the optical fibers.

In some embodiments of the foregoing cable portion, the second substrate end portion may be opposite to the first substrate end portion.

In some embodiments of the foregoing cable portion, the substrate portion may include two opposed substrates that are configured to sandwich the middle portion of the cable portion there between. In some embodiments of any of the foregoing fiber optic cassettes, the two opposed substrates may be secured together via an adhesive portion.

In some embodiments of any of the foregoing cable portion, the middle portion of the cable portion may be embedded in the substrate portion.

In some embodiments of any of the foregoing cable portions, each of the optical fibers may be terminated at a first end by a plug and all of the optical fibers are terminated at a second end by a multifiber plug.

In accordance with various aspects of the disclosure, a fiber optic cassette configured to provide enhanced protection of optical fibers therein may include any of the foregoing cable portions and a body portion configured to receive the cable portion.

In some embodiments of any of the foregoing fiber optic cassettes, the body portion may include a front portion, a back portion opposite the front portion, and a pair of opposed side portions connecting the front portion and the back portion, and the front portion, the back portion, and the opposed side portions together may define a receiving region structurally configured to receive the cable portion.

In some embodiments of any of the foregoing fiber optic cassettes, an engagement portion may be configured to extend into the receiving region and retain the substrate portion in the receiving region. In some embodiments, the substrate portion may include an opening portion configured to permit the engagement portion to pass there through and engage the substrate portion so as to retain the substrate portion in the receiving region. In some embodiments, the engagement portion comprises a pair of flexible fingers configured to be inserted through the opening portion and engage a surface of the substrate portion so as to retain the substrate portion in the receiving region.

Various aspects of the cassette, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1A provides an exploded raised front right perspective view of an exemplary fiber optic cassette in accordance with various aspects of the disclosure;

FIG. 1B provides a raised front right perspective view of an exemplary fiber optic cassette in accordance with various aspects of the disclosure;

FIG. 2 provides an exploded raised rear right perspective view of an exemplary optical fiber and substrate in accordance with various aspects of the disclosure; and

FIG. 3 provides a raised front right perspective view of an exemplary fiber optic cable arrangement in accordance with various aspects of the disclosure.

### DETAILED DESCRIPTION OF EMBODIMENTS

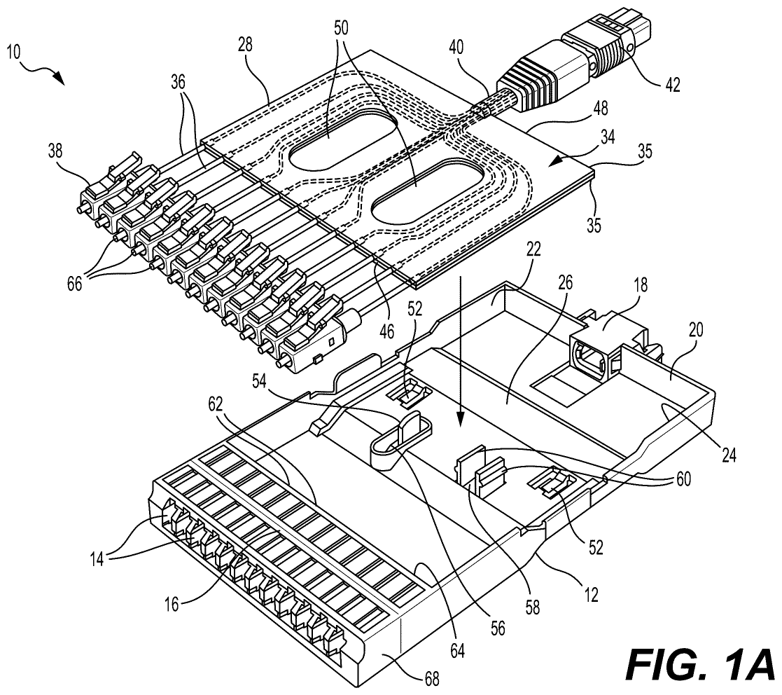

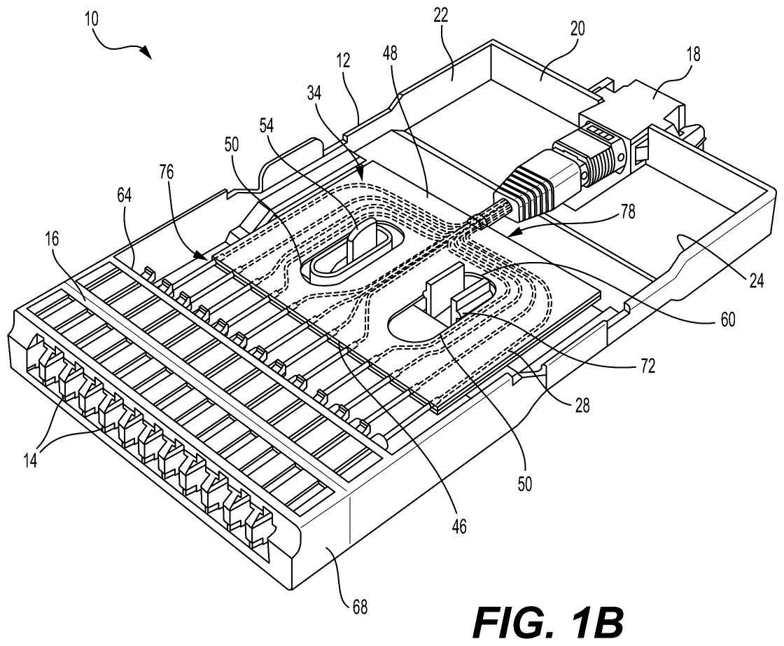

Referring now to FIGS. 1A and 1B, an exemplary fiber optic cassette 10 may include a body portion 12, for example, a cassette body, a first receiving portion 14, and a second receiving portion 18. As shown in FIGS. 1A and 1B, the first receiving portion 14 may comprise a plurality of optical fiber receptacles 14 arranged along a front portion 16 of the body portion 12, and the second receiving portion 18 may comprise a multi-fiber receptacle 18 arranged along a rear portion 20 of the body portion 12 opposite the front portion 16.

In some embodiments, the optical fiber receptacles 14 may be configured for receiving a standard LC type plug, for example, terminating a single fiber optic cable or the like (both not shown). Additionally, in some embodiments, the spacing between the optical fiber receptacles 14 is such that any two optical fiber receptacles 14 can receive two plugs (also not shown) in a duplex configuration or any four optical fiber receptacles can receive four plugs (also not shown) in a quad configuration. In some embodiments, the multi-fiber receptacle 18 may comprise a back-to-back receptacle configured for receiving and mating standard MPO type plugs terminating a twelve fiber (12F) multi-fiber cable (both not shown) or the like. The receptacle may include a first port open to an inner side of the body portion 12 and a second port open to an exterior of the body portion.

Still referring to FIGS. 1A and 1B, the cassette body 12 further comprises a pair of opposed outer side portions or outer side edges 22, 24 interconnecting the front portion 16 and the rear portion 20 of the body portion 12. Together, the front portion 16, the rear portion 20, and the side portions 22, 24 define a receiving region 26, for example, a cable receiving region, there between.

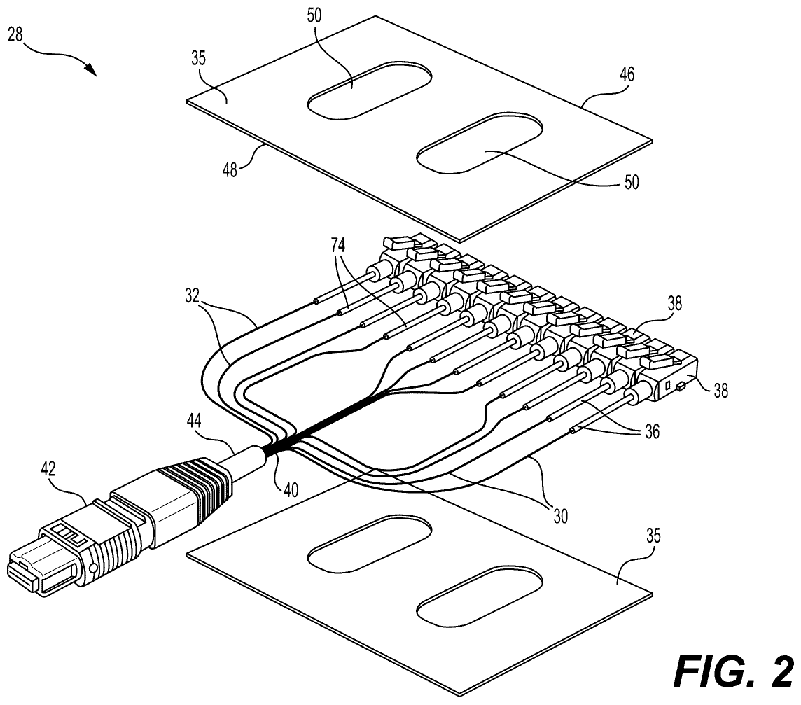

Referring to FIG. 2, in addition to FIGS. 1A and 1B, the cassette 10 further comprises a cable portion or cable arrangement 28 dimensioned to fit within the receiving region 26. In the embodiment of FIG. 2, the cable portion 28 comprises a plurality of optical fibers 30, for example, bare fibers. A middle portion 32 of each of the optical fibers 30 is protected by a substrate portion 34. The middle portions 32 may be secured to the substrate portion 34 using an adhesive or the like or may be embedded into the substrate portion 34. In some aspects, the substrate portion 34 may comprise a flexible substrate, such as, for example, a substrate manufactured from Mylar™.

As shown in FIG. 2, in an exemplary embodiment, the optical fibers 30 may be placed between two opposed substrates 35 that are secured together using an adhesive, for example, an epoxy adhesive, to form the substrate portion 34. In some aspects, the two opposed substrates 35 may be secured to one another by heating the substrates 35 and/or the adhesive and/or by applying pressure to the substrates 35 and/or the adhesive. The optical fibers 30 may comprise any size bare fiber, such as, for example, 250 μm, 400 μm, 600 μm, etc. It should be understood that the smaller fiber sizes will leave little to no impression in the substrates 35 when sandwiched there between, while larger fiber sizes may leave a more visible impression in the substrates 35.

Still referring to FIG. 2, in addition to FIGS. 1A and 1B, each optical fiber 30 is terminated at a first end 36 by a plug 38. In some embodiments, the plug 38 is an LC type plug and dimensioned to fit into a standard LC type receptacle. Each of the optical fibers 30 may be additionally terminated at a second end 40 by a multi-fiber plug 42 such as, for example, a standard MPO type plug which is dimensioned to fit into a standard MPO type receptacle. In some aspects, the second ends 40 may be illustratively encased in a cover portion 44, for example, a boot or a cable jacket.

Still referring to FIG. 2, in addition to FIGS. 1A and 1B, the middle portions 32 of the optical fibers 30 are held in the substrate 34 such that the first ends 36 and their respective plugs 38 stand free of a first end 46 of the substrate 34. In some embodiments, the first ends 36 and their respective plugs 38 may be equally spaced along the first end of the substrate 34. Similarly, the second ends 40, and particularly the cover portion 44, stand free of a second end 48 of the substrate 34 opposite the first end 36. In some aspects, the substrate 34 may include an open portion 50, for example, a pair of oval slot-like apertures that are arranged side-by-side in parallel in the substrate 34 on either side of a center thereof.

Referring back to FIGS. 1B and 2, in addition to FIG. 1A, during assembly of the substrate 32 into the receiving region 26, the plugs 38 may be inserted into respective ones of a plurality of receptacles 62 illustratively molded in the inside face 64 of the cassette body 12. Each of the receptacles 62 is in a back-to-back relationship with a respective one of the receptacles 14 arranged along the front 16 of the cassette body 12 and such that a ferrule 66 of the optical fiber 30 terminated by one of the plugs 38 and inserted into one of the receptacles 62 is aligned for optical communication with a ferrule of an optical fiber terminated by a plug (not shown) that is inserted into a respective one of the receptacles 14 arranged along the front portion 16 of the body portion 12. Additionally, the multi-fiber plug 42 may be inserted into the receiving portion 18, for example, a multi-fiber receptacle, at first port open to an inner side of the body portion 12.

Still referring to FIGS. 1A and 1B, in an exemplary embodiment, the receptacles 14 may be molded together as a block portion 68, for example, a block of twelve (12) LC type receptacles. Similarly, an inside face 64 of the body portion 12 adjacent to the front portion 16 may comprise a plurality of receptacles 70 molded or otherwise formed therein. In an exemplary embodiment, the receptacles 70 are configured to receive a standard LC type plug 38 for terminating a single optical fiber cable or the like. The block portion 68 of receptacles 14 is attached to the front portion 16, for example by sonic welding, a suitable adhesive, or the like.

Referring back to FIG. 1A, in some embodiments, the cassette 10 may include an engaging portion 52, for example, a pair of tray engaging stabilizing tabs extending away from the body portion 12. In some embodiments, the cassette 10 may include an actuating portion 54, which extends from the body portion 12 through an aperture 56, and/or a securing portion 58 comprising, for example, a pair of flexible fingers 60 that extend from the body portion 12.

Still referring to FIGS. 1A and 1B, the substrate 34 is configured to be retained within the receiving region 26 by the pair of flexible fingers 60 of the securing portion 58, which projects through the open portion 50, for example, via an aligned one of the apertures in the substrate 34. In this regard, each of the flexible fingers 60 of the securing portion 58 may comprise a tab 72 that is configured to extend over a surface of the substrate 34 and hold the substrate 34 in place relative to the body portion 12. Additionally, the actuator 54 may be configured to project through the open portion, for example, via an aligned one of the apertures in the substrate 34.

Referring to again to FIG. 2, as discussed above, the first ends 36 of the optical fibers 30 are evenly spaced along the front 46 of the substrate 34. Additionally, each of the first ends 36 may be protected by a respective protective portion 74, for example, a furcation tube, a cladding, or a cable jacket. When the cable arrangement is held by the substrate portion 34, the protective portion 74 extends between a respective region 76 of the substrate portion 34 and a respective one of the plugs 38. Similarly, the second ends 40 may be protected by the cover portion 44 which, extends between a region 78 of the substrate portion 34 and the multi-fiber plug 42. As a result, the optical fibers 30 are protected from the multi-fiber plug 42 to their respective plugs 38.

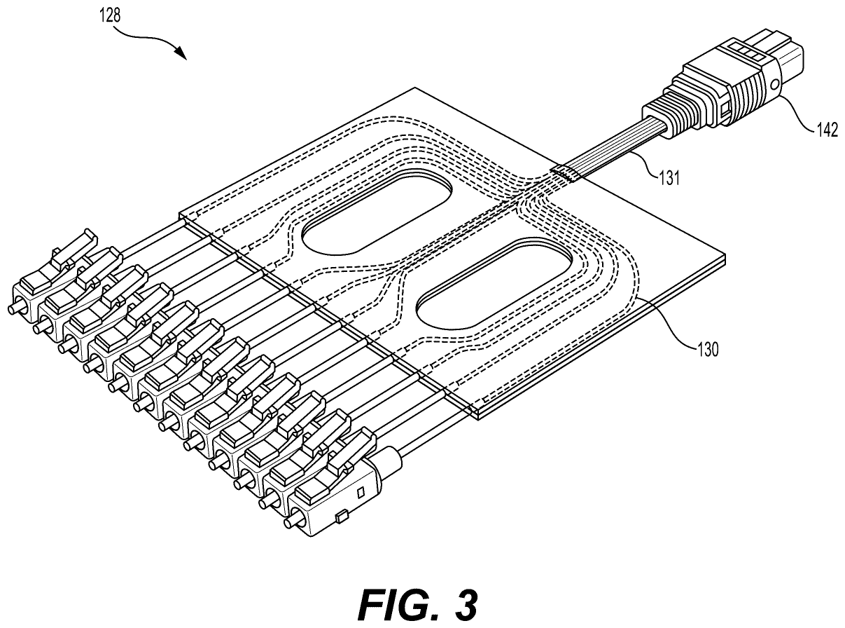

Referring now to FIG. 3, an exemplary cable portion 128 according to various aspects of the disclosure may be similar to the cable portion illustrated in FIGS. 1A, 1B, and 2, except for a ribbon fiber cable 131 that includes, for example, intermittently bonded optical fibers 130 that can be separated from one another. As a result of the strength provided by the ribbon fiber cable 131, a multi-fiber plug 142 may terminate the ribbon fiber cable 131 without the need for a boot. It should be appreciated that, in some aspects, the ribbon fiber cable may comprise a continuously bonded ribbon fiber cable.

The aforementioned cable portions 28, 128 may be manufactured in various ways. For example, the optical fibers 30, 130 may be laid out onto a first one of the substrates 35 by an automated machine. Before the second one of the substrates 35 is adhered to the first one of the substrates 35, the fibers 30, 130 are placed through the protective portions 74. The plugs 38 can terminate the fibers 30, 130 at any time after the protective portions 74 are in place, for example, before or after the second one of the substrates 35 is adhered to the first one of the substrates 35. Similarly, the multi-fiber plug 142 shown in FIG. 3 can terminate the ribbon fiber cable 131 at any time, for example, before or after the second one of the substrates 35 is adhered to the first one of the substrates 35. On the other hand, in the embodiment of FIGS. 1A, 1B, and 2, if the cover 44 is a boot of the multi-fiber plug 42, the multi-fiber plug 42 must terminate the fibers 30 before the second one of the substrates 35 is adhered to the first one of the substrates 35 so that the cover can be sandwiched between the substrates 35. As mentioned above, the two substrates 35 can be adhered to one another via an adhesive portion and/or application of pressure and/or heat.

It should be understood that the substrate portion 34 is configured to support and protect the optical fibers 30, 130 in an organized and efficient manner, as compared to conventional fiber optic cassettes that house exposed optical fibers. Such exposed optical fibers are susceptible to damage due to frictional movements relative to the cassette body and/or human interaction.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A fiber optic cassette configured to provide enhanced protection of optical fibers therein, comprising:
a body portion comprising a front portion, a back portion opposite the front portion, and a pair of opposed side portions;
a cable portion comprising:
an arrangement of optical fibers, and
a substrate portion configured to support the arrangement of optical fibers,
wherein each of the optical fibers is terminated at a first end by a plug and all of the optical fibers are terminated at a second end by a multifiber plug;
wherein the front portion, the back portion, and the opposed side portions are structurally configured to together define a receiving region that is configured to receive the cable portion;
wherein the first ends of the optical fibers stand free of and are equally spaced along a first end of the substrate, and the second ends of the optical fibers stand free of a second end of the substrate opposite the first substrate end;
wherein the first ends of the optical fibers are each covered by a protective portion and the second ends of the optical fibers are covered by a cover portion;
wherein an engagement portion is configured to extend into the receiving region and retain the substrate portion in the receiving region; and
wherein a first end portion of the protective portion is configured to be at least partly surrounded by the substrate portion, a portion of the cover portion is configured to be at least partly surrounded by the substrate portion, and a middle portion of each of the optical fibers that is configured to extend from the first end portion to the portion of the cover portion that is configured to be at least partly surrounded by the substrate portion such that the cassette is configured to provide enhanced protection of the optical fibers in the receiving region.

2. The fiber optic cassette of claim 1, wherein substrate portion comprises two opposed substrates that are configured to sandwich the middle portion of the cable portion there between.

3. The fiber optic cassette of claim 2, wherein the substrates are configured to be secured together by an adhesive portion.

4. The fiber optic cassette of claim 1, wherein the middle portion of the cable portion is at least partially embedded in the substrate portion.

5. The fiber optic cassette of claim 1, wherein the substrate portion includes an opening portion that is configured to permit the engagement portion to pass there through and engage the substrate portion so as to at least partially retain the substrate portion in the receiving region.

6. The fiber optic cassette of claim 5, wherein the engagement portion comprises a pair of flexible fingers that are configured to be inserted through the opening portion and engage a surface of the substrate portion so as to at least partially retain the substrate portion in the receiving region.

7. A fiber optic cassette configured to provide enhanced protection of optical fibers therein, comprising:
a cable portion comprising:
an arrangement of optical fibers, and
a substrate portion configured to support the arrangement of optical fibers,
a body portion configured to receive the cable portion;
wherein the optical fibers each include a first fiber end portion that is configured stand free of the substrate and the second fiber end portion that is configured to stand free of a second end of the substrate opposite the first substrate end;
wherein the first fiber end portion is configured to be at least partially covered by a protective portion and the second fiber end portion is configured to be at least partially covered by a cover portion; and
wherein a substrate facing protective portion of the protective portion is configured to be at least partially surrounded by the substrate portion, a substrate facing cover portion of the cover portion is configured to be at least partially surrounded by the substrate portion, and a middle fiber portion of each of the optical fibers is configured to extend from the first fiber end portion to the substrate facing cover portion of the cover portion that is at least partially surrounded by the substrate portion such that the cassette is configured to provide enhanced protection of at least one of the arrangement of optical fibers.

8. The fiber optic cassette of claim 7, wherein the body portion comprises a front portion, a back portion opposite the front portion, and a pair of opposed side portions connecting the front portion and the back portion, and wherein the front portion, the back portion, and the opposed side portions together define a receiving region that is structurally configured to receive the cable portion.

9. The fiber optic cassette of claim 7, wherein substrate portion comprises two opposed substrates that are configured to sandwich the middle portion of the cable portion there between.

10. The fiber optic cassette of claim 9, wherein the substrates are secured together via an adhesive.

11. The fiber optic cassette of claim 7, wherein the middle portion of the cable portion is embedded in the substrate portion.

12. The fiber optic cassette of claim 7, further comprising an engagement portion that is configured to extend into the receiving region and retain the substrate portion in the receiving region.

13. The fiber optic cassette of claim 12, wherein the substrate portion includes an opening substrate portion that configured to permit the engagement portion to pass there through and engage the opening substrate portion so as to retain the substrate portion in the receiving region.

14. The fiber optic cassette of claim 13, wherein the engagement portion comprises a pair of flexible fingers that are configured to be at least partially inserted through the opening portion so as to engage a surface of the substrate portion and retain the substrate portion in at least a portion of the receiving region.

15. The fiber optic cassette of claim 14, wherein each of the optical fibers is terminated at a first end by a plug and all of the optical fibers are terminated at a second end by a multifiber plug.

16. A cable portion configured to provide enhanced protection of optical fibers, comprising:
an arrangement of optical fibers;
a substrate portion configured to hold at least a portion of the arrangement of optical fibers such that at least a first optical fiber end portion of the arrangement of optical fibers stands free of a first substrate end portion of the substrate portion and a second optical fiber end portion of the arrangement of optical fibers stand free of a second substrate end portion of the substrate portion at a location that is opposite to the first substrate end portion of the substrate portion;
wherein the first optical fiber end portion of the arrangement of optical fibers is configured to be at least partially covered by a protective portion and the second optical fiber end portion of the arrangement of optical fibers is configured to be at least partially covered by a cover portion; and
wherein a substrate facing protective portion of the protective portion is configured to be at least surrounded by the substrate portion, a substrate facing cover portion of the cover portion is configured to be at least surrounded by the substrate portion, and an intermediate optical fiber portion of the arrangement of optical fibers is configured to extend from the first end portion of the substrate facing cover portion of the cover portion that is at least partially surrounded by the substrate portion such that the cable portion is configured to provide enhanced protection of the optical fibers.

17. The cable portion of claim 16, wherein substrate portion comprises two opposed substrates that are configured to sandwich the middle portion of the cable portion there between.

18. The cable portion of claim 17, wherein the substrates are secured together by an adhesive portion.

19. The cable portion of claim 16, wherein the middle portion of the cable portion is embedded in the substrate portion.

20. The cable portion of claim 16, wherein each of the optical fibers is terminated at a first end by a plug and all of the optical fibers are terminated at a second end by a multifiber plug.

21. A fiber optic cassette configured to provide enhanced protection of optical fibers therein, comprising:
the cable portion of claim 16; and
a body portion configured to receive the cable portion.

22. The fiber optic cassette of claim 21, wherein the body portion comprises a front portion, a back portion opposite the front portion, and a pair of opposed side portions connecting the front portion and the back portion, and wherein the front portion, the back portion, and the opposed side portions together define a receiving region structurally configured to receive the cable portion.

23. The fiber optic cassette of claim 22, further comprising an engagement portion configured to extend into the receiving region and retain the substrate portion in the receiving region.

24. The fiber optic cassette of claim 23, wherein the substrate portion includes an opening portion configured to permit the engagement portion to pass there through and engage the substrate portion so as to retain the substrate portion in the receiving region.

25. The fiber optic cassette of claim 24, wherein the engagement portion comprises a pair of flexible fingers configured to be inserted through the opening portion and engage a surface of the substrate portion so as to retain the substrate portion in the receiving region.

26. The cable portion of claim 16, wherein the second substrate end portion is opposite to the first substrate end portion.
